(19) United States
(12) Patent Application Publication
(10) Pub. No.: US 2026/0181345 A1
(43) Pub. Date: Jun. 25, 2026

(54) SOUND IMAGE LOCALIZATION PROCESSING METHOD AND SOUND IMAGE LOCALIZATION PROCESSING DEVICE

(71) Applicant: YAMAHA CORPORATION, Hamamatsu-shi (JP)

(72) Inventors: Hiroomi SHIDOJI, Hamamatsu-shi (JP); Dai HASHIMOTO, Hamamatsu-shi (JP)

(21) Appl. No.: 19/410,147

(22) Filed: Dec. 5, 2025

(30) Foreign Application Priority Data
Dec. 24, 2024 (JP) 2024-227185

(51) Int. Cl. H04S 7/00; H04R 5/02

(52) U.S. Cl. CPC H04S 7/302; H04R 5/02; H04S 7/305; H04S 2400/11

(57) ABSTRACT

A sound image localization processing method includes inputting a sound source signal of a same sound source and localization information of the sound source to a first signal processing unit and a second signal processing unit; generating the first sound signal by subjecting the sound source signal to first localization processing based on the localization information and position information of the first speaker group to localize a sound of the sound source at a position indicated by the localization information; and generating the second signal by subjecting the sound source signal to second localization processing based on the localization information and position information of the second speaker group to localize the sound of the sound source at the position indicated by the localization information.

### CROSS-REFERENCE TO RELATED APPLICATIONS

This application is based on and claims priority under 35 USC 119 from Japanese Patent Application No. 2024-227185 filed on Dec. 24, 2024, the contents of which are incorporated herein by reference.

### TECHNICAL FIELD

The present disclosure relates to a sound image localization processing method and a sound image localization processing device to be used in a live venue.

### BACKGROUND ART

Patent Literature 1 discloses an acoustic control device capable of individually selecting a source sound source to be used in each individual space in a predetermined space and preventing an influence of acoustic leaking from another individual space in each individual space.

### CITATION LIST

### Patent Literature

Patent Literature 1: Jp2009-143495a

### SUMMARY OF INVENTION

However, in the acoustic control device of Patent Literature 1, a situation in which the same sound signal is output from speakers installed at different positions is not taken into consideration. For example, a user may want to localize and output the same sound signal at the same sound source position from speakers installed in different regions. In addition, for example, depending on installation conditions of a plurality of speakers installed in an acoustic space, a region that cannot be covered by a first speaker group may be covered by installing a second speaker group. In such a case, a sound source that moves across the first speaker group and the second speaker group may not be able to clearly provide localization.

An object of the present disclosure is to provide a sound image localization processing method for preventing a decrease in localization feeling caused by an installation condition of a speaker and movement of a sound source in an acoustic space.

The sound image localization processing method of the present disclosure is performed in a sound image localization system. The sound image localization system includes a first speaker group installed in an acoustic space, a second speaker group installed at a position different from the first speaker group in the acoustic space, a first signal processing unit that generates a first sound signal to be output to the first speaker group, and a second signal processing unit that generates a second sound signal to be output to the second speaker group. The sound image localization processing method includes inputting a sound source signal of a same sound source and localization information of the sound source to the first signal processing unit and the second signal processing unit; generating the first sound signal by subjecting the sound source signal to first localization processing based on the localization information and position information of the first speaker group to localize a sound of the sound source at a position indicated by the localization information; and generating the second signal by subjecting the sound source signal to second localization processing based on the localization information and position information of the second speaker group to localize the sound of the sound source at the position indicated by the localization information.

With the sound image localization processing method according to the present disclosure, it is possible to prevent a decrease in localization feeling caused by an installation condition of a speaker, movement of a listener, and movement of a sound source in an acoustic space.

### BRIEF DESCRIPTION OF DRAWINGS

FIG. 1 is a block diagram illustrating an example of a configuration of a sound image localization processing device 1 according to a first embodiment;

FIG. 2 is a transparent perspective view schematically illustrating a room R1 as an example of an acoustic space according to the first embodiment;

FIG. 3 is a block diagram illustrating an example of a functional configuration of a processor 15;

FIG. 4 is a flowchart illustrating an operation of the sound image localization processing device 1 according to the first embodiment;

FIG. 5 illustrates an example of reproduction information according to the first embodiment;

FIG. 6 is a schematic diagram illustrating an example of classification of sound types in a time waveform of impulse response data;

FIG. 7 is a transparent perspective view schematically illustrating the room R1 as an example of an acoustic space according to a second embodiment;

FIG. 8 is a flowchart illustrating an operation of a sound image localization processing device 1A according to the second embodiment;

FIG. 9 illustrates an example of information indicating a correspondence relation between a main speaker and a front fill speaker; and

FIG. 10 illustrates an example of information indicating the correspondence relation between the main speaker and the front fill speaker.

### DESCRIPTION OF EMBODIMENTS

Hereinafter, a sound image localization processing device according to an embodiment of the present disclosure will be described with reference to the drawings. In the drawings, the same portions are denoted by the same reference numerals. In a second embodiment and subsequent embodiments, descriptions of matters common to a first embodiment will be omitted, and only differences will be described. In particular, similar operations and effects of similar configurations will not be described in each embodiment.

### First Embodiment

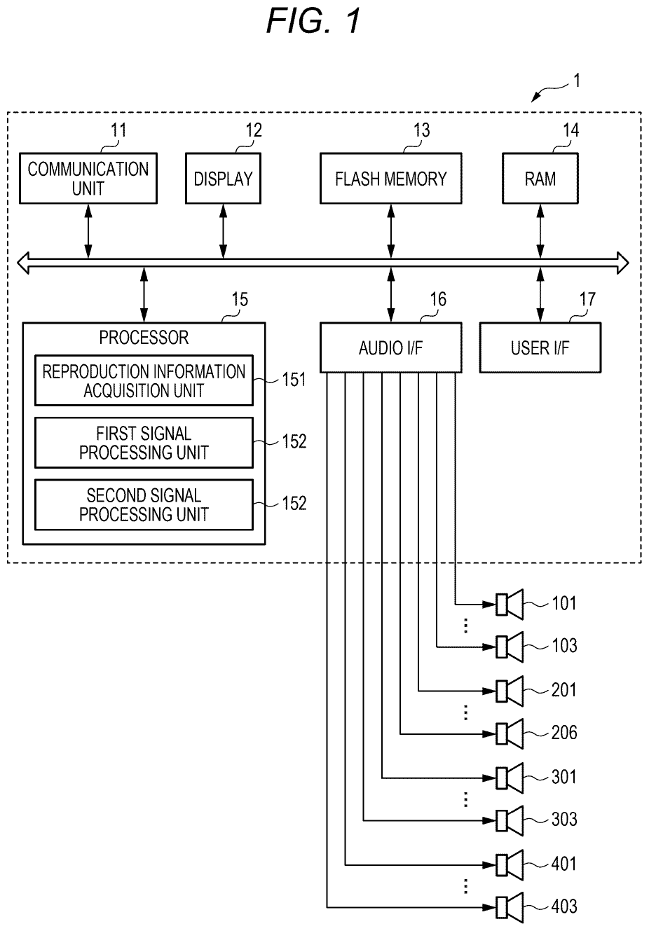

FIG. 1 is a block diagram illustrating an example of a configuration of a sound image localization processing device 1 according to the first embodiment.

As illustrated in FIG. 1, the sound image localization processing device 1 includes a communication unit 11, a display 12, a flash memory 13, an RAM 14, a processor 15, an audio I/F 16, and a user I/F 17.

The sound image localization processing device 1 includes a personal computer, a smartphone, a tablet computer, or the like. In addition, an acoustic device such as an audio mixer or hardware dedicated to signal processing is also an example of the sound image localization processing device.

The communication unit 11 allows communication with another device such as a server. The communication unit 11 has a wireless communication function such as Bluetooth (registered trademark) or Wi-Fi (registered trademark) or a wired communication function such as USB or LAN. The communication unit 11 receives, for example, a sound source signal.

The display 12 includes an LCD or the like. The display 12 displays, for example, a reproduction information setting screen as illustrated in FIG. 5.

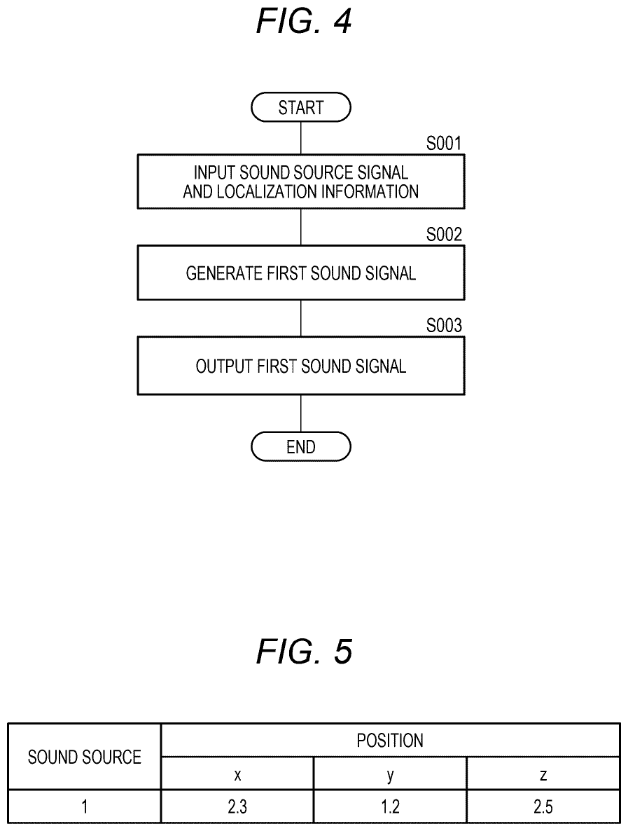

The processor 15 includes a CPU, a DSP, a system on a chip (SoC), or the like. The processor 15 performs various operations by reading a program from the flash memory 13, which is a storage medium, and temporarily storing the program in the RAM 14. The processor 15 implements functional configurations of a reproduction information acquisition unit 151, a first signal processing unit 152, a second signal processing unit 153, and the like by the read program. The reproduction information acquisition unit 151, the first signal processing unit 152, and the second signal processing unit 153 perform processing of S001, S002, and S003 illustrated in the flowchart of FIG. 4, respectively. The program does not need to be stored in the flash memory 13. For example, the processor 15 may download the program from another device such as a server as necessary and temporarily store the program in the RAM 14.

The audio I/F 16 includes an analog audio terminal or a digital audio terminal. The audio I/F 16 is connected to main speakers SP101 to SP103, front fill speakers SP201 to SP206, ceiling speakers SP301 to SP303, and surround speakers SP401 to SP403.

In the present embodiment, the first signal processing unit 152 of the processor 15 outputs a sound signal to the main speakers SP101 to SP103, the ceiling speakers SP301 to SP303, and the surround speakers SP401 to SP403 via the audio I/F 16. The second signal processing unit 153 outputs a sound signal to the front fill speakers SP201 to SP206 via the audio I/F 16. The main speakers SP101 to SP103, the front fill speakers SP201 to SP206, the ceiling speakers SP301 to SP303, and the surround speakers SP401 to SP403 may be connected via the communication unit 11, and the sound signal may be output to the speakers via the communication unit 11.

In the present disclosure, the main speakers SP101 to SP103 correspond to first speakers, and the front fill speakers SP201 to SP206 correspond to second speakers.

The user I/F 17 is an example of an operation unit. The user I/F 17 includes a mouse, a keyboard, a touch panel, or the like. The user I/F 17 receives a user operation. The touch panel may be stacked on the display 12.

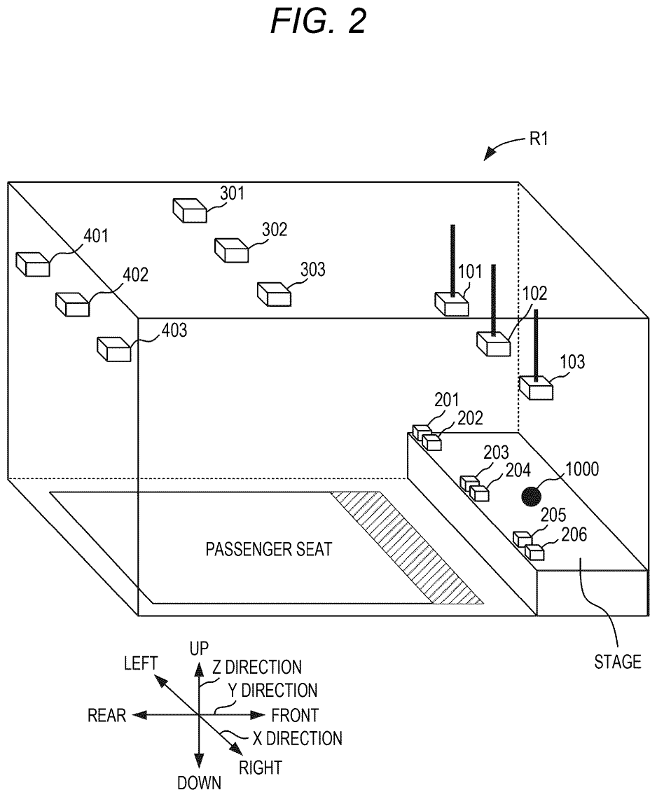

FIG. 2 is a transparent perspective view schematically illustrating a room R1 which is an example of an acoustic space according to the first embodiment. The room R1 constitutes an acoustic space having a substantially rectangular parallelepiped shape. The room R1 is, for example, a live venue having a stage. The stage is installed in front of the room R1. In addition, a passenger seat on which a listener sits is installed behind the room R1. A shape of the room R1 is not limited to the example of FIG. 1.

The main speaker SP101, the main speaker SP102, and the main speaker SP103 are installed in the room R1. In the present embodiment, the main speakers SP101 to SP103 are installed to be suspended from a ceiling along a left-right direction at positions where sound can be output to the rear of the room R1. In addition, the main speaker SP101, the main speaker SP102, and the main speaker SP103 are installed such that sound emission directions thereof are directed to the passenger seat.

The front fill speaker SP201, the front fill speaker SP202, the front fill speaker SP203, the front fill speaker SP204, the front fill speaker SP205, and the front fill speaker SP206 are installed in the room R1. In the present embodiment, the front fill speakers SP201 to SP206 are installed on the stage along the left-right direction so as to be able to emit a sound toward the passenger seat near the stage and near directly below the main speaker. Hatched portions in FIG. 2 indicate regions (output regions) where the sound emitted from the front fill speakers SP201 to SP206 reaches.

In addition, the ceiling speaker SP301, the ceiling speaker SP302, and the ceiling speaker SP303 are installed in the room R1. In the present embodiment, the ceiling speakers SP301 to SP303 are installed on the ceiling at a center of the passenger seat along the left-right direction.

In addition, the surround speaker SP401, the surround speaker SP402, and the surround speaker SP403 are installed in the room R1. In the present embodiment, the surround speakers SP401 to SP403 are installed along the left-right direction on a wall surface to the rear of the passenger seat.

However, in the present disclosure, the ceiling speakers SP301 to SP303 and the surround speakers SP401 to SP403 are not essential components, and the number of installed speakers and installation positions thereof are not limited to this example.

In the present embodiment, the main speaker SP101 and the front fill speakers SP201 and SP202 have a correspondence relation. The main speaker SP102 and the front fill speakers SP203 and SP204 have a correspondence relation. The main speaker SP103 and the front fill speakers SP205 and SP206 have a correspondence relation. In other words, the number of front fill speakers is larger than the number of main speakers, and two front fill speakers are installed for one main speaker.

The main speaker and the front fill speaker having the above-described correspondence relation are installed at substantially the same position when viewed in an up-down direction. That is, the main speaker and the front fill speaker are installed at different positions in the height direction (up-down direction).

However, in the present disclosure, the installation number and the installation positions of the main speakers and the front fill speakers are not limited to this example. Specifically, the main speaker is not necessarily suspended from the ceiling. In addition, the front fill speaker is not necessarily installed on the stage. The main speaker and the front fill speaker may not be installed differently in the height direction, and may be installed at different positions. In addition, three or more front fill speakers may be installed for one main speaker.

In addition, the main speaker and the front fill speaker may be of the same model or different models.

In addition, one or a plurality of subwoofers may be installed in the room R1. The one or a plurality of subwoofers output sounds in a frequency band lower than the sounds output by the main speakers SP101 to SP103 and the front fill speakers SP201 to SP206. When a plurality of subwoofers are installed, it is preferable that the plurality of subwoofers output the same sound signals as the sound signals output by the main speakers SP101 to SP103 and the front fill speakers SP201 to SP206 such that the sound signals are localized at the same position.

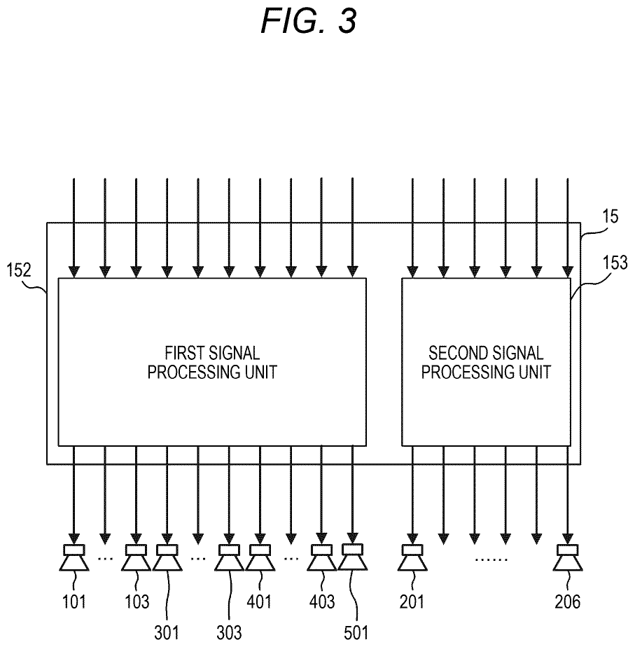

FIG. 3 is a block diagram illustrating an example of a functional configuration of the processor 15. The number of input/output ports of the first signal processing unit 152 is larger than the number of input/output ports of the second signal processing unit 153. The first signal processing unit 152 generates, for example, sound signals to be output to the main speakers SP101 to SP103, the ceiling speakers SP301 to SP303, the surround speakers SP401 to SP403, and a subwoofer SW501. The second signal processing unit 153 generates sound signals to be output to the front fill speakers SP201 to SP206. Although FIG. 3 illustrates an example in which one processor 15 functionally constitutes a plurality of signal processing units, a plurality of processors may constitute a plurality of signal processing units, respectively.

### Specific Contents of Sound Processing

FIG. 4 is a flowchart illustrating an operation of the sound image localization processing device 1 according to the first embodiment.

The reproduction information acquisition unit 151 of the processor 15 acquires the sound source signal received via the communication unit 11 and localization information of a sound source (S001).

FIG. 5 is a diagram illustrating an example of reproduction information according to the first embodiment. As illustrated in FIG. 5, the reproduction information is information indicating localization information indicating a type of the sound source signal and a localization position of the sound source. The localization information is three-dimensional logical coordinates with a predetermined position as an origin. In the example of FIG. 5, the localization information is three-dimensional coordinates, but may be two-dimensional (planar) coordinates. In the present embodiment, the position indicated by the three-dimensional coordinates in FIG. 5 is a position of a sound source 1000 in FIG. 2.

The reproduction information acquisition unit 151 may acquire the sound source signal and the localization information of the sound source via the audio I/F 16 instead of the communication unit 11. In addition, the sound source signal and the localization information of the sound source may be stored in the flash memory 13. In addition, the user may input the localization information of the sound source by selecting a place where the sound image is to be localized from the schematic diagram of the room R1 displayed on the display 12.

The first signal processing unit 152 of the processor 15 converts the acquired localization information into physical coordinates of the room R1, and generates a first sound signal by subjecting the sound source signal to first localization processing based on the localization information and the position information of the main speakers SP101 to SP103 such that a sound of the sound source is localized at the position indicated by the physical coordinates (S002).

The second signal processing unit 153 of the processor 15 converts the acquired localization information into physical coordinates of the room R1, and generates a second sound signal by subjecting the sound source signal to second localization processing based on the localization information and the position information of the front fill speakers SP201 to SP206 such that the sound of the sound source is localized at the position indicated by the physical coordinates (S003).

Specifically, in the first localization processing, the first sound signal is generated by calculating a level balance of the sound signals output to the main speakers SP101 to SP103 and adjusting a level of the sound signals such that a sound image of the sound source signal is localized at the corresponding position based on the localization information and the position information of the main speakers SP101 to SP103. The position information of the main speaker may be stored in the flash memory 13 or may be input by the user of the sound image localization processing device 1 each time. In addition, the first signal processing unit 152 may adjust output timings of the sound signals to be output to the main speakers SP101 to SP103 such that sound signals of the sound source signal are localized at corresponding positions.

In the second localization processing, the second sound signal is generated by calculating a level balance of the sound signals to be output to the front fill speakers SP201 to SP206 and adjusting a level of the sound signals such that the sound image of the sound source signal is localized at the corresponding position based on the localization information and the position information of the front fill speakers SP201 to SP206. The position information of the front fill speaker may be stored in the flash memory 13 or may be input by the user of the sound image localization processing device 1 each time. The second signal processing unit 153 may adjust output timings of the sound signals to be output to the front fill speakers SP201 to SP206 such that sound signals of the sound source signals are localized at corresponding positions.

Accordingly, the sound image localization processing device 1 can localize both a sound source of the first sound signal output from the main speakers SP101 to SP103 and a sound source of the second sound signal output from the front fill speakers SP201 to SP206 at a target position (for example, position of sound source 1000 illustrated in FIG. 2).

Here, the main speakers SP101 to SP103 installed in the room R1 need to output a sound to the entire passenger seat. For example, in the example of FIG. 2, the main speakers SP101 to SP103 are suspended from the ceiling. Therefore, depending on the installation situation of the main speakers SP101 to SP103, a listener in front of the passenger seat (for example, hatched portion in FIG. 2) may unclearly hear the sound output from the main speakers SP101 to SP103. Therefore, the front fill speakers SP201 to 206 are installed to deliver the sound to the listener in front of the passenger seat. In this case, the listener in front of the passenger seat mainly listens to the sound output from the front fill speakers SP201 to SP206. However, in the related art, the sound output from the front fill speaker is not subjected to sound image localization processing. Therefore, the sound heard by the listener in front of the passenger seat does not have a localization feeling.

In a case where the sound image localization position of the sound source signal moves from the rear of the passenger seat to the front of the passenger seat, for example, when the sound image localization position is to the rear of the passenger seat, the sound heard by the listener is mainly a clear sound with a localization feeling output from the main speakers SP101 to SP103, the ceiling speakers SP301 to SP303, and the surround speakers SP401 to SP403. On the other hand, when the sound image localization position is in front of the passenger seat, the sound heard by the listener is mainly an unclear sound with a localization feeling output from the front fill speakers SP201 to 206. That is, when the sound image localization position of the sound source signal moves from the rear of the passenger seat to the front of the passenger seat, the listener may feel as if the sound localization feeling is suddenly lost.

However, the sound image localization processing device 1 according to the present embodiment can output the same sound source signal from the main speakers SP101 to SP103 (first speaker group) and the front fill speakers SP201 to SP206 (second speaker group) having different output regions so as to be localized at the same position in one acoustic space. Therefore, the listener in front of the passenger seat, such as the hatched portion in FIG. 2, listens to a clear sound with a sound image localization feeling, which is output from the second speaker group. Similarly, the listener to the rear of the passenger seat listens to a clear sound with a sound image localization feeling, which is output from the first speaker group. In addition, even when the listener to the rear of the passenger seat moves to the front of the passenger seat beyond the output region of the first speaker group, the listener always listens to the sound localized in the sound source 1000. In addition, even when the sound source position is to the rear of the passenger seat, the localization feeling of the sound output from the front fill speaker is clearly felt. That is, the sound image localization processing device 1 can prevent deterioration of the localization feeling caused by the installation condition of the speaker, the movement of the listener, and the movement of the sound source in the acoustic space.

In addition, since the second speaker group is installed on the stage, a sound is output from a place close to a performer on the stage. Therefore, the listener in front of the passenger seat can obtain a more realistic listening experience.

In addition, the first sound signal described above may include not only a direct sound but also an indirect sound. The indirect sound referred to herein corresponds to a first indirect sound of the present disclosure, and includes a first initial reflection sound and a first late reverberation sound.

Similarly, the second sound signal described above may include not only a direct sound but also an indirect sound. The indirect sound referred to herein corresponds to a second indirect sound of the present disclosure, and includes a second initial reflection sound and a second late reverberation sound.

In this case, the first signal processing unit 152 generates the first initial reflection sound by calculating a level balance of the sound signals output to the main speakers SP101 to SP103 and adjusting a level of the sound signals so as to localize a sound image of each sound source of the first initial reflection sound at the corresponding position based on localization information and position information of the main speakers. Similarly, the second signal processing unit 153 generates the second initial reflection sound by calculating a level balance of the sound signals output to the front fill speakers SP201 to SP206 and adjusting a level of the sound signal so as to localize a sound image of each sound source of the second initial reflection sound at the corresponding position based on localization information and position information of the front fill speakers.

In order to reduce a burden of signal processing, the second signal processing unit 153 may receive the first initial reflection sound from the first signal processing unit 152 and output the received first initial reflection sound as the second initial reflection sound.

The first signal processing unit 152 and the second signal processing unit 153 generate the first late reverberation sound and the second late reverberation sound, respectively, by convolving impulse response data of the room R1 to the sound source signal, for example. The impulse response data is measured, for example, by emitting a test sound (pulse sound) at the position of the sound source 1000 in the room R1 and collecting the test sound with a measurement microphone (not illustrated). Alternatively, the impulse response may be acquired by simulation based on, for example, a sound ray method or a virtual image method. The sound ray method is a method of tracking a trajectory (sound ray) of a sound emitted from a sound source and calculating a time pattern of energy of a sound ray passing through a listening position. In the simulation using the sound ray method, when each sound ray is regarded as a virtual sound image of a reverberation sound, a direction, an arrival time, and an arrival level from each virtual sound source at a listening position are obtained based on the energy of the sound ray in a sound receiving region. The virtual image method is a method of creating a virtual image of a sound source (imaginary sound source) with respect to a wall surface of a space as a virtual sound source and obtaining a direction, an arrival time, and an arrival level from each virtual sound source at a listening position. The first signal processing unit 152 and the second signal processing unit 153 may perform processing of generating an impulse response of a head-related transfer function representing the direction, the arrival time, and the arrival level of each virtual sound source obtained by the simulation, and convolving the impulse response to the sound source signal to localize the indirect sound. The impulse response data may be stored in the flash memory 13. In addition, the impulse response data may be downloaded from a server or the like (not illustrated) each time.

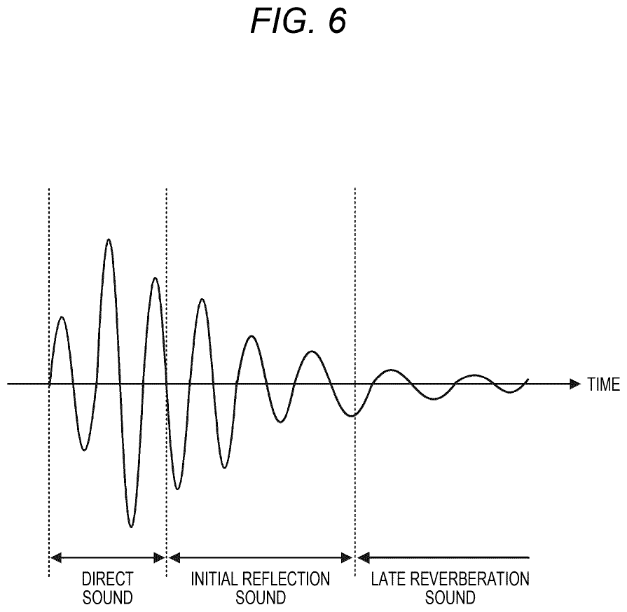

Here, the impulse response data will be described. FIG. 6 is a schematic diagram illustrating an example of classification of sound types in a time waveform of the impulse response data. A horizontal axis of a graph represents time, and a vertical axis thereof represents an amplitude. As illustrated in FIG. 6, the impulse response can be distinguished into a direct sound, an initial reflection sound, and a late reverberation sound arranged on the time axis. In this case, the first signal processing unit 152 and the second signal processing unit 153 acquire data of the impulse response including the direct sound, the initial reflection sound, and the late reverberation sound, cut out the initial reflection sound and the late reverberation sound, and convolve the initial reflection sound and the late reverberation sound to the sound source signal. Alternatively, the first signal processing unit 152 and the second signal processing unit 153 may perform processing of localizing the indirect sound by subjecting the sound source signal to level delay filter processing having a delay amount and an attenuation amount corresponding to each virtual sound source obtained by the simulation.

The first signal processing unit 152 and the second signal processing unit 153 may generate the first late reverberation sound and the second late reverberation sound by adding reverb preferred by the user to the sound source signal.

In addition, the second indirect sound may not necessarily include the second late reverberation sound. In other words, the second signal processing unit 153 outputs only the second direct sound and the second initial reflection sound from the front fill speaker without generating the second late reverberation sound. The initial reflection sound is a sound with determined arrival direction and phase, but since the arrival direction and the phase of the late reverberation sound are random, the listener of the entire venue does not feel uncomfortable even when the reverberation sound is output from the main speaker.

### Second Embodiment

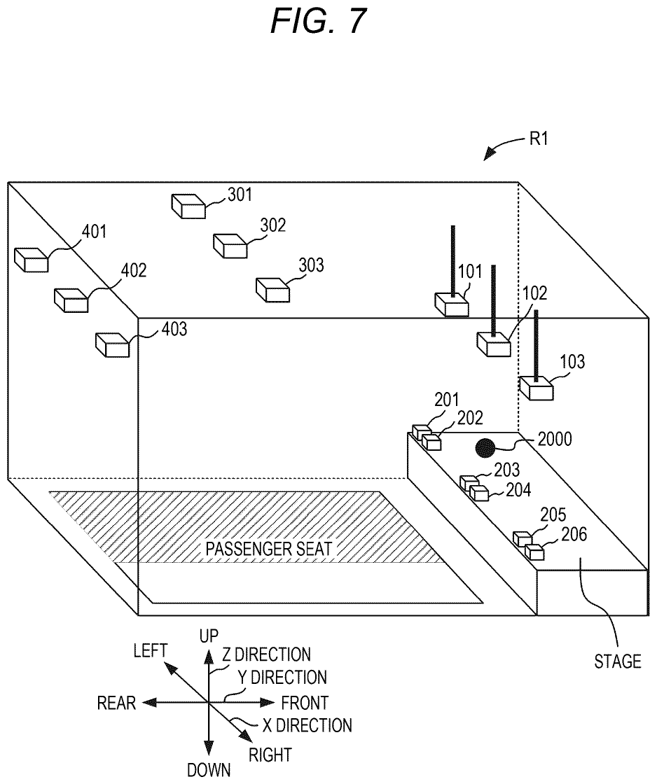

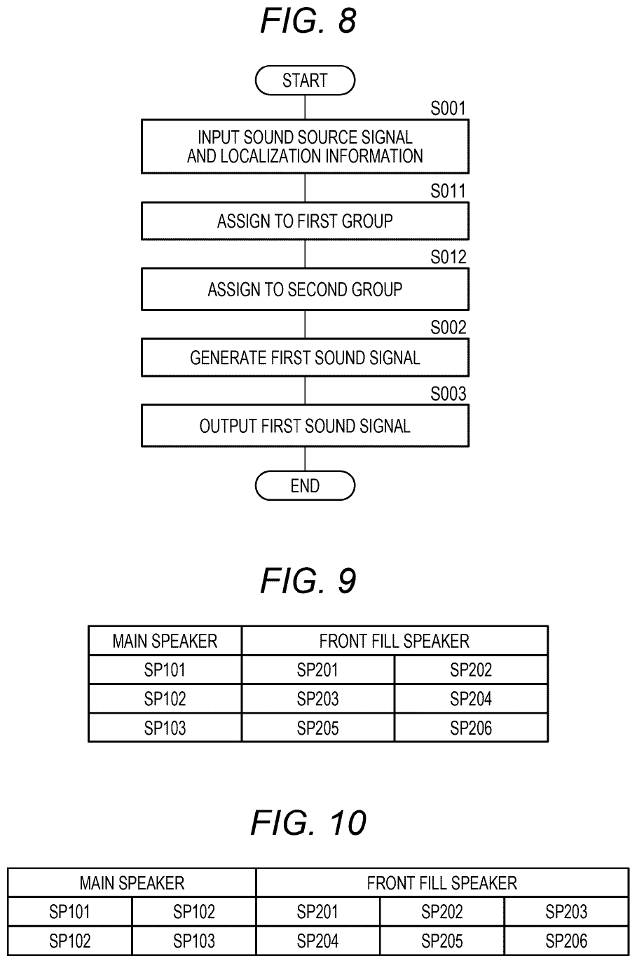

FIG. 7 is a transparent perspective view schematically illustrating the room R1 which is an example of an acoustic space according to the second embodiment. FIG. 8 is a flowchart illustrating an operation of a sound image localization processing device 1A according to the second embodiment.

The sound image localization processing device 1A according to the second embodiment is different from the sound image localization processing device 1 in that the sound image localization processing device 1A further has a function of determining a speaker that outputs a sound signal according to a sound image localization position of a sound source signal.

The first signal processing unit 152 of the sound image localization processing device 1A assigns a sound source signal to a first group of main speakers based on localization information of the sound source signal and position information of the main speakers (S011).

Specifically, the first signal processing unit 152 determines a main speaker that outputs the sound source signal according to the localization position of the acquired sound source signal, and assigns the main speaker to the first group. The first signal processing unit 152 determines the main speaker based on, for example, information indicating a correspondence relation between the localization position of the sound source signal stored in the flash memory 13 and the main speaker that outputs the sound source signal. In the example of FIG. 7, the sound source 2000 indicating the localization position of the sound source signal is located to the left of the stage. In this case, the first signal processing unit 152 assigns, for example, the main speaker SP101 and the main speaker SP102 to the first group. The user may designate a main speaker that outputs the sound source signal via the user I/F 17 according to the localization position of the sound source signal.

The second signal processing unit 153 of the sound image localization processing device 1A assigns a sound source signal to a second group of front fill speakers based on localization information of the sound source signal and position information of the front fill speakers (S012).

Specifically, the second signal processing unit 153 determines a front fill speaker that outputs a sound source signal according to the localization position of the acquired sound source signal, and assigns the front fill speaker to the second group. For example, the second signal processing unit 153 determines a front fill speaker based on information indicating a correspondence relation between the main speaker and the front fill speaker stored in the flash memory 13.

FIG. 9 is an example of the information indicating the correspondence relation between the main speaker and the front fill speaker. In this case, the second signal processing unit 153 assigns, to the second group, the front fill speakers SP201 to SP204 having a correspondence relation with the main speaker SP101 and the main speaker SP102 assigned to the first group. The user may designate a front fill speaker that outputs a sound source signal via the user I/F 17 according to the localization position of the sound source signal.

Accordingly, the user of the sound image localization processing device 1A can localize a first sound signal and a second sound signal at the position of the sound source 2000 and limit a range in which the first sound signal and the second sound signal are output to a range indicated by the hatched portion in FIG. 7.

The correspondence relation between the main speaker and the front fill speaker is not limited to the example of FIG. 9. Although an example in which one main speaker has a correspondence relation with two front fill speakers has been described in the above example, the number of front fill speakers having a correspondence relation with one main speaker may not be two. Specifically, one main speaker may have a correspondence relation with three or more front fill speakers. In addition, two main speakers and three front fill speakers may have a correspondence relation.

FIG. 10 is an example of information indicating the correspondence relation between the main speaker and the front fill speaker. As illustrated in FIG. 10, the main speakers SP101 and SP102 have a correspondence relation with the front fill speakers SP201 to SP203. In addition, the main speakers SP102 and SP103 have a correspondence relation with the front fill speakers SP204 to SP206. As illustrated in FIG. 7, when the sound source 2000 is located to the left of the stage, the first signal processing unit 152 assigns, for example, the main speaker SP101 and the main speaker SP102 to the first group, and the second signal processing unit 153 assigns the front fill speakers SP201 to SP203 to the second group.

In this way, the sound image localization processing device 1A can flexibly set a speaker that outputs a sound signal according to a position where a sound source signal is localized. In addition, the user of the sound image localization processing device 1A can intuitively control a range of a sound field to be created according to the position where the sound source signal is localized.

The description of the present embodiment should be considered to be illustrative in all respects and not restrictive. The scope of the present disclosure is indicated by the claims rather than the above-described embodiments. Further, the scope of the present disclosure includes the scope equivalent to the claims.

What is claimed is:

1. A sound image localization processing method of a sound image localization system, the sound image localization system including
a first speaker group installed in an acoustic space,
a second speaker group installed at a position different from the first speaker group in the acoustic space,
a first signal processing unit that generates a first sound signal to be output to the first speaker group, and
a second signal processing unit that generates a second sound signal to be output to the second speaker group,
the sound image localization processing method comprising:
inputting a sound source signal of a same sound source and localization information of the sound source to the first signal processing unit and the second signal processing unit;
generating the first sound signal by subjecting the sound source signal to first localization processing based on the localization information and position information of the first speaker group to localize a sound of the sound source at a position indicated by the localization information; and
generating the second signal by subjecting the sound source signal to second localization processing based on the localization information and position information of the second speaker group to localize the sound of the sound source at the position indicated by the localization information.

2. The sound image localization processing method according to claim 1, wherein
the first speaker group and the second speaker group are installed at different positions in a height direction.

3. The sound image localization processing method according to claim 1, wherein
the first localization processing is performed by assigning the sound source signal to a first group of the first speaker group based on the localization information and the position information of the first speaker group, and
the second localization processing is performed by assigning the sound source signal to a second group of the second speaker group based on the localization information and the position information of the second speaker group.

4. The sound image localization processing method according to claim 1, wherein
a number of speakers in the second speaker group is larger than a number of speakers in the first speaker group, and
a plurality of second speakers of the second speaker group are installed corresponding to one first speaker of the first speaker group.

5. The sound image localization processing method according to claim 1, wherein
the first localization processing includes localization processing of a first direct sound and a first indirect sound of the sound source signal, and
the second localization processing includes localization processing of a second direct sound and a second indirect sound of the sound source signal.

6. The sound image localization processing method according to claim 5, wherein
the first indirect sound includes a first initial reflection sound and a first late reverberation sound, and
the second indirect sound includes a second initial reflection sound and a second late reverberation sound.

7. The sound image localization processing method according to claim 5, wherein
the first indirect sound includes a first initial reflection sound and a first late reverberation sound, and
the second indirect sound includes a second initial reflection sound.

8. A sound image localization processing device of a sound image localization system,
the sound image localization system including
a first speaker group installed in an acoustic space,
a second speaker group installed at a position different from the first speaker group in the acoustic space,
a first signal processing unit configured to generate a first sound signal to be output to the first speaker group, and
a second signal processing unit configured to generate a second sound signal to be output to the second speaker group,
the sound image localization processing device comprising:
a memory storing instructions; and
a processor that executes the instructions to:
input a sound source signal of a same sound source and localization information of the sound source to the first signal processing unit and the second signal processing unit;
generate the first sound signal by subjecting the sound source signal to first localization processing based on the localization information and position information of the first speaker group to localize a sound of the sound source at a position indicated by the localization information; and
generate the second sound signal by subjecting the sound source signal to second localization processing based on the localization information and position information of the second speaker group to localize the sound of the sound source at the position indicated by the localization information.

9. The sound image localization processing device according to claim 8, wherein
the first speaker group and the second speaker group are installed at different positions in a height direction.

10. The sound image localization processing device according to claim 8, wherein the processor implements the instructions to
perform the first localization processing by assigning the sound source signal to a first group of the first speaker group based on the localization information and the position information of the first speaker group, and
perform the second localization processing by assigning the sound source signal to a second group of the second speaker group based on the localization information and the position information of the second speaker group.

11. The sound image localization processing device according to claim 8, wherein
a number of speakers in the second speaker group is larger than a number of speakers in the first speaker group, and
a plurality of second speakers of the second speaker group are installed corresponding to one first speaker of the first speaker group.

12. The sound image localization processing device according to claim 8, wherein
the first localization processing includes localization processing of a first direct sound and a first indirect sound of the sound source signal, and
the second localization processing includes localization processing of a second direct sound and a second indirect sound of the sound source signal.

13. The sound image localization processing device according to claim 12, wherein
the first indirect sound includes a first initial reflection sound and a first late reverberation sound, and
the second indirect sound includes a second initial reflection sound and a second late reverberation sound.

14. The sound image localization processing device according to claim 12, wherein
the first indirect sound includes a first initial reflection sound and a first late reverberation sound, and
the second indirect sound includes a second initial reflection sound.
